(19) United States
(12) Patent Application Publication
(10) Pub. No.: US 2018/0321898 A1
(43) Pub. Date: Nov. 8, 2018

(54) PERSONALIZED BRAINWAVE CONTENT

(71) Applicant: FUJITSU LIMITED, Kawasaki-shi (JP)

(72) Inventors: Yuko OKUBO, Berkeley, CA (US); Jun WANG, San Jose, CA (US)

(73) Assignee: FUJITSU LIMITED, Kawasaki-shi (JP)

(21) Appl. No.: 15/589,944

(22) Filed: May 8, 2017

(51) Int. Cl. G06F 3/16; H04L 29/08; G06Q 10/10; G06F 17/30

(52) U.S. Cl. CPC G06F 3/165; H04L 67/306; G06F 17/30761; G06Q 10/1093; H04L 67/22

(57) ABSTRACT

A method of providing personalized brainwave music to a user is provided. The method may include receiving user data for a user and generating personalized brainwave music for the user based on the user data. The method may also include providing the personalized brainwave music to the user at a designated time.

### FIELD

The embodiments discussed herein relate to personalized brainwave content.

### BACKGROUND

Brainwave entrainment, which may include brainwave entertainment (e.g., brainwave entertainment music), may include using stimuli, such as visual, auditory, and/or tactile stimuli, to alter brainwave frequencies and/or brain states.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of providing personalized brainwave music to a user may include receiving user data for the user. The method may also include generating personalized brainwave music for the user based on the user data. Further, the method may include providing the personalized brainwave music to the user at a designated time.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts an example system for generating personalized content for a user and/or delivering the personalized content to the user;

FIG. 2 is a diagram of an example flow that may be used in generating personalized content for a user and/or delivering the personalized content to the user;

FIG. 3 is a diagram of an example flow that may be used to categorize one or more user activities into one or more brainwave groups;

FIG. 4 illustrates an example mapping table include activity types, brainwave groups, and music types;

FIG. 5 is a diagram of an example flow that may be used to generate brainwave music for one or more user activities; and

FIG. 6 is a block diagram of an example computing system.

### DESCRIPTION OF EMBODIMENTS

Some embodiments discussed herein are related to generating personalized content for a user, delivering the personalized content to the user, and/or playing the personalized content via a user device. More specifically, some embodiments may relate to generating, delivering, and/or playing personalized brainwave music and/or user notifications. Compared to conventional systems that are configured to play ambient music, some embodiments described herein may generate and/or convey content (e.g., brainwave music and/or notifications) for a user based on user data, such as a user profile, one or more user schedules (e.g., a user's daily schedule), user preferences, physiological information of the user, and user movement data. Further, according to various embodiments, personalized content (e.g., brainwave music and/or notifications) may be automatically adjusted based on, for example, user feedback, user comments, one or more user conditions (e.g., context data), and/or any other user data (e.g., updates to the user data). For example, personalized content (e.g., brainwave music and/or notifications) may enhance, and possibly optimize, everyday life of a user.

Various embodiments may enable a user to generate brainwave music (e.g., via an application program) based on user data including the user's music preferences (e.g., music from a user's music collection). Further, various embodiments may enable a user to listen to music that is most suitable to the user's conditions (e.g., user activities). Further, various embodiments, may convey notifications (e.g., verbal and/or visual messages) to a user (e.g., to remind the user of and/or mentally prepare the user for one or more upcoming activities). In some embodiments, personalized content, such as personalized brainwave music, may be automatically generated and played for the user. Further, various embodiments may be configured to detect one or more user responses to the music (e.g., user vital signs and/or user feedback), and modify the personalized content (e.g., change music or turn off the music) in response to the one or more user responses. As one example, if it is detected that the user is exercising, the speed of the music may be increased. As another example, if it is detected that the user is resting, the speed of the music may be decreased. As yet another example, if it is detected that the user is experiencing discomfort, the music may be turned off.

In contrast to conventional systems that may not generate content based on user data, embodiments disclosed herein may generate personalized content (e.g., brainwave music and/or notifications), which may be used to modify human behavior and/or assist user in accomplishing individualized goals (e.g., to address physical, emotional, cognitive, and/or social needs of users).

Embodiments of the present disclosure will be explained with reference to the accompanying drawings.

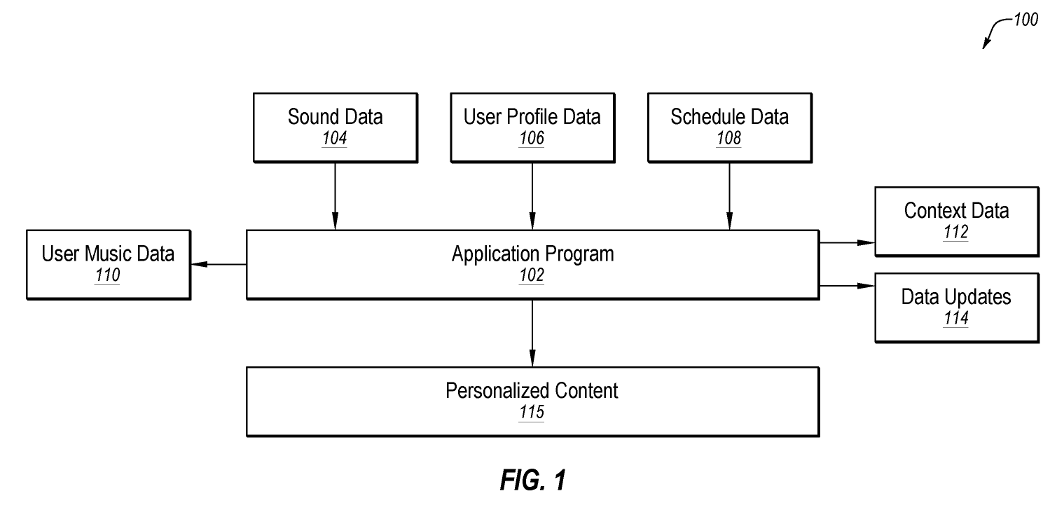

FIG. 1 illustrates an example system 100 for generating and/or delivering personalized content 115, which may include personalized brainwave music and/or one or more personalized notifications. System 100 includes an application program 102, sound data 104 (e.g., brainwave sounds and/or tones), user profile data 106, user schedule data 108, user music data (e.g., a user's favorite music and/or music preferences) 110, context data 112, and data updates 114, which may include user feedback and/or user comments. According to various embodiments described more fully herein, application program 102 may be configured to generate personalized content (e.g., brainwave music and/or one or more notifications) 115 based on user data, such as sound content 104, user profile data 106, user schedule data 108, user music data (e.g., user's favorite music) 110, context data 112, and/or data updates 114.

In some embodiments, sound data 104 may include brainwave data, such as brainwave visual data and/or brainwave audio data (e.g., beat and/or tones). More specifically, for example, sound data 104 may include brainwave patterns. Brainwave patterns, which may be measured via, for example, electroencephalography (EEG) systems, may include four frequency spectrums including Delta waves (e.g., 0.5 Hz to 4 Hz), Theta waves (e.g., 4 Hz to 8 Hz), Alpha waves (e.g., 8 Hz to 14 Hz), and Beta waves (e. g., 14 Hz to 40 Hz). For example, Delta waves may be associated with deep sleep, Theta waves may be associated with drowsiness, Alpha waves may be associated with an alert, relaxed state, and Beta waves may be associated with a highly focused and alert state. Brainwave beats/tones may include, for example, binaural beats, monaural beats, isotones, etc.

Applying brainwave stimuli to a user may modify the user's brain frequency. For example, if a user's brain is in a Beta state of high alertness and a stimulus of 10 Hz is applied to the user, the user's brain frequency may change into the Alpha state, which may result in increased relaxation.

User profile data 106 may include data related to a user, such as the user's gender, age, language, residence, interests, preferences (e.g., music preferences, such as favorite music, favorite artists, favorite genre, etc.), personality type, etc. Music data 110 may include user audio data (e.g., audio files) (e.g., the user's music and/or sounds).

Schedule data 108 may include any data related to a user's schedule (e.g., daily, monthly, yearly, etc.) (e.g., items on a user's electronic calendar). More specifically, schedule data 108 may include data related to the user's sleep schedule, commute schedule, work schedule, eating schedule, social schedule, exercise schedule, etc.

Data updates 114 may include any updates to a user's schedule, comments provided by a user, and/or any other user feedback (e.g., any user response to the personalized content 115).

Context data 112 may include real-time data, such as the user's location data (e.g., location, time, weather, etc.), the user's social media data (e.g., data from one or more social media accounts), current activity data for the user (e.g., whether the user is working, exercising, commuting, resting, etc.), and the user's vital signs (e.g., heartrate, stress level, body temperature, etc.).

As described more fully herein, system 100 may be configured to generate personalized content 115 (e.g., brainwave music and/or notifications) based on user data. Stated another way, system 100 may generate brainwave music and/or notifications personalized for the user. The brainwave music and/or the notifications may be conveyed to the user at designated times. Further, system 100 may be configured to adjust the brainwave music and/or the notifications based on user data and more specifically, data updates 114. For example, in some embodiments, a user, via one or more user comments, may designate one or more schedule events. More specifically, the user may designate a schedule event as “important,” “high priority,”, “need more time,” etc. In response to the user comments, system 100 may adjust the brainwave music and/or the notifications that may be provided to the user.

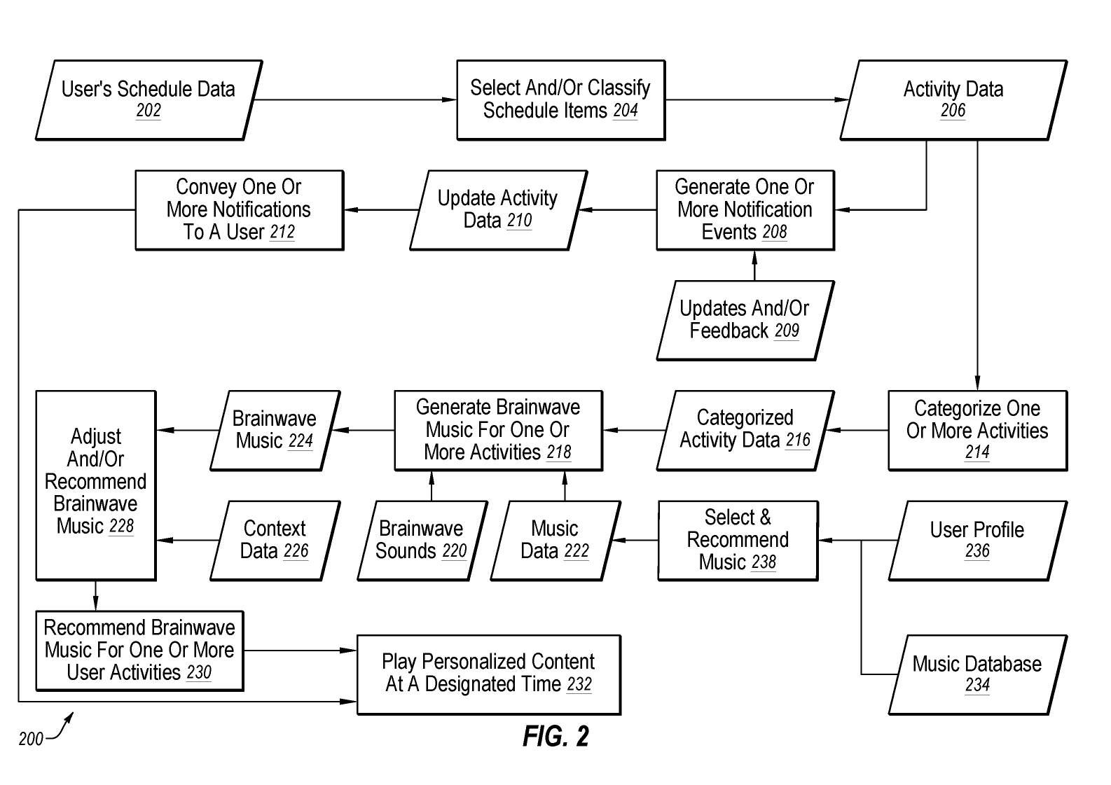

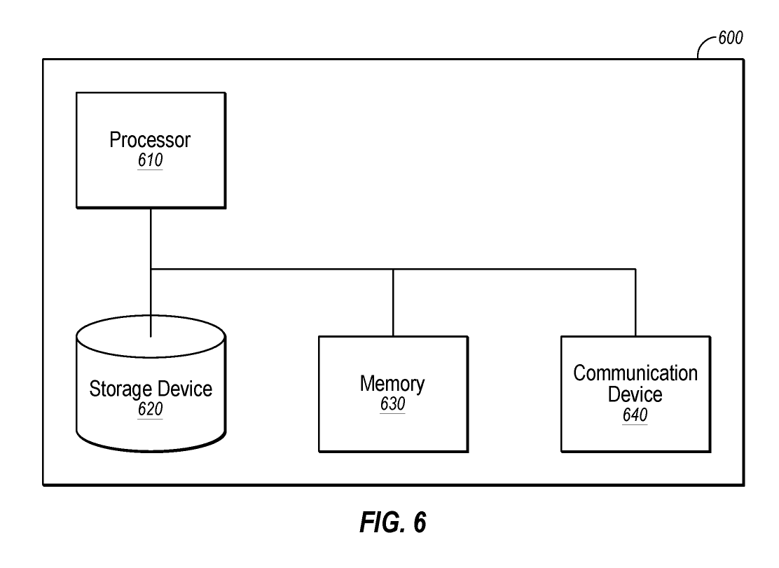

FIG. 2 is a diagram of an example flow 200 that may be used in generating personalized content for a user and/or delivering the personalized content to the user, in accordance with at least one embodiment of the present disclosure. Flow 200 may be performed by any suitable system, apparatus, or device. For example, system 100 (FIG. 1), system 600 (FIG. 6), or one or more of the components thereof may perform one or more of the operations associated with flow 200. In these and other embodiments, program instructions stored on a computer readable medium may be executed to perform one or more of the operations of flow 200.

At block 204, based on a user's schedule data 202, schedule items (e.g., activities and/or situations) for the user for a time period (e.g., a week, a month, a year, etc.) may be selected and/or classified to generate activity data 206. Activity data 206 may include, for example, one or more lists of activities for a time period (e.g., a list of activities for a week, a list of activities for a month, a list of activities for a year). For example, schedule data 202 may include schedule data 108 of FIG. 1.

For example, one or more schedule items may be selected from the user's calendar (e.g., electronic calendar). The schedule items may include, for example, leisure and/or social activities (e.g., “play basketball,” “brunch,” “go to park,” etc.), daily activities (e.g., “dinner,” “exercise,” “commute,” “sleep,” etc.), and/or work-related activities (e.g., “meetings, “business lunch,” etc.). More specifically, for example, a user's schedule may include one or more weekday daily routine items, such as “wake up at 4:30 AM,” “leave home at 5 am,” “dinner preparation and eat at 6 PM,” “sleep at 9 PM.” The user's schedule may also include, for example, one or more weekend daily routine items, such as “shopping” and “laundry.” The user's schedule may further include one or more work related items, such as “project meeting at 11 AM” and “meeting at 4 PM.”In addition, the user's schedule may include one or more leisure items, such as “dog park at 10 AM on Sunday.”

Further, at block 208, based on activity data 206 and schedule updates and/or user feedback (e.g., user comments) 209, a notification event for one or more activities in activity data 206 may be generated and/or adjusted to generate an updated activity data 210. For example, updates and/or user feedback 209 may include data updates 114 of FIG. 1.

For example, a notification event (e.g., to send a notification) may be scheduled at a specified time before an activity. More specifically, for example, a notification event for a daily routine item may be scheduled for ten minutes prior to the activity, and a notification event for a work related item may be scheduled for fifteen minutes prior to the activity.

Further, for example, based on one or more updates (e.g., schedule changes, user feedback, and/or user comments), one or more notification events may be adjusted via changing a schedule time and/or changing a classification (e.g., “important”, “high priority,” “optional,” etc.) of an activity. For example, a user may add an additional activity such as “client meeting at 11:30 AM” to their activity list. Thus, in this example, a notification event may be created and a notification reminding the user of the client meeting may be sent to the user (e.g., at 11:15 AM).

As another example, a user may provide one or more comments for one or more activities, such as “cannot miss” for work a social activity item, “need to prepare” for a work related item, and “optional” for a leisure items. Further, for example, in response to a user comment, a scheduled notification event may be adjusted. As an example, for the “cannot miss” comment, the scheduled notification event may be moved up five minutes (e.g., from ten minutes prior to the activity to fifteen minutes prior to the activity). As another example, for the “need to prepare” comment, the scheduled notification event may be moved up fifteen minutes (e.g., from fifteen minutes prior to the activity to thirty minutes prior to the activity). As yet another example, for the “optional” comment, the scheduled notification event may be moved back five minutes (e.g., from ten minutes prior to the activity to five minutes prior to the activity).

At block 212, one or more notifications for one or more activities in activity data 210 may be conveyed to the user at a schedule time. For example, a notification such as “leave for work in 15 minutes,” “your next meeting is in 15 minutes,” “review presentation,” and/or “remember to bring a change of clothes” may be conveyed to the user at one or more designated times.

At block 214, one or more activities in activity data 206 may be categorized into one or more suitable brainwave groups to generate categorized activity data 216. More specifically, for example, the user may assign (e.g., via one or more comments) one or more activities in activity data 206 an identifier, such as “important,” “optional,” or “urgent.” Further, in some embodiments, an activity may include one or more descriptors, such as “rest,” “nap,” “exercise” “commute,” “meeting preparation,” “breakfast,” “lunch,” and “dinner.” Based on one or more identifiers, descriptors, and/or user comments, each activity in activity data 206 may be classified.

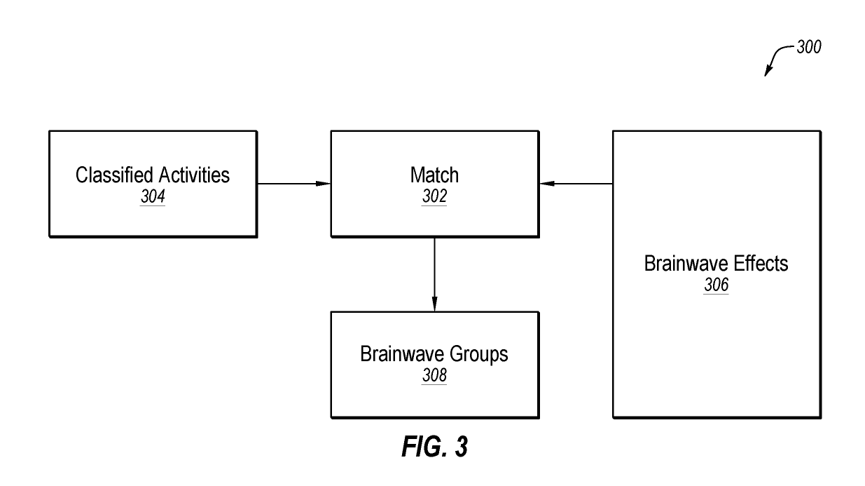

Further, one or more of the classified activities may be matched to one or more brainwave effects to categorize the one or more of the activities into brainwave groups. For example, FIG. 3 is a diagram of an example flow 300 that may be used in matching one or more classified activities to one or more brainwave effects to categorize the one or more classified activities into brainwave groups, in accordance with at least one embodiment of the present disclosure. Flow 300 may be performed by any suitable system, apparatus, or device. For example, system 100 (FIG. 1), system 600 (FIG. 6), or one or more of the components thereof may perform one or more of the operations associated with flow 300. In these and other embodiments, program instructions stored on a computer readable medium may be executed to perform one or more of the operations of flow 300.

At block 302, the one or more classified activities 304 may be matched with one or more brainwave effects of brainwave effects 306 to categorize the one or more classified activities 304 into brainwave groups 308, such as Delta (e.g., deep sleep, unconscious), Alpha (e. g., alert but relaxed), Beta (e.g., consciously alert, logical), Theta (e.g., relaxed, meditated) or Gamma (e.g., linking information, formation of ideas, linguistic processing, learning). Brainwave effects 306 may include, for example only, “morning coffee,” “espresso shot,” “morning meditation,” “focused and alert,” “critical thinking,” “problem solving,” “confidence boost,” “euphoria,” “stress reduction,” lucid dreaming,” “headache relief,” etc.

As an example, a classified activity, such as “important meeting” may be matched with various brainwave effects, such as “concentration,” “focused and alert,” “confidence boost,” and/or “problem solving” to categorize the “important meeting” activity into the “Beta” brainwave group.

Modifications, additions, or omissions may be made to the flow 300 without departing from the scope of the present disclosure. For example, the operations of flow 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments. In short, flow 300 is merely one example of categorizing one or more classified activities into brainwave groups, and the present disclosure is not limited to such.

With reference again to FIG. 2, at block 218, for one or more categorized activities of categorized activity data 216, brainwave tones/beats 220 (e.g., sound data 104; see FIG. 1) may be mixed with user music data (e.g., the user's favorite music and/or sounds) 222 (e.g., user music data 110; see FIG. 1) to generate brainwave music 224 for the one or more activities. For example, music may be mixed with brainwave tones/beats via any suitable device and/or process (e.g., via a brainwave generator and/or brainwave tuner). Brainwave music 224 may be selected based on an activity type and/or a brainwave group.

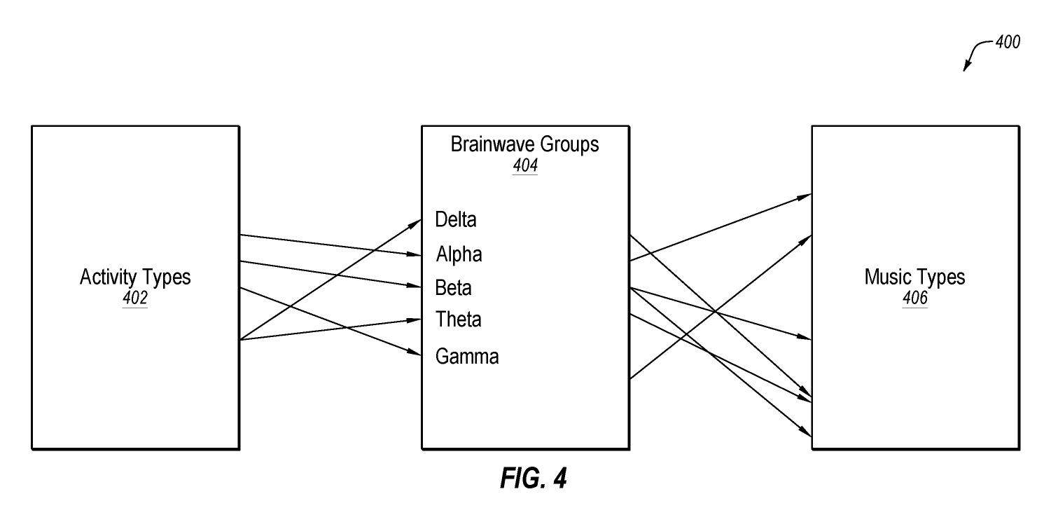

More specifically, with reference to a mapping table 400 illustrated FIG. 4, in some embodiments, each activity in categorized activity data 216 may be assigned an activity type 402, such as “meeting,” “exercise,” “wake up,” “prepare report,” etc. Further, each activity in categorized activity data 216 may be mapped to one or more brainwave groups 404 (e.g., Delta, Alpha, Beta, Theta, or Gamma). Further, each brainwave group may be mapped to one or more music types 406, such as, for example, exercise music, relaxation music, music that increases confidence, music that enhances focus, and music that increases positivity. Thus, in some embodiments, one or more activities in categorized activity data 216 may be matched with one or more music types. Thus, according to various embodiments, brainwave music may be generated for the one or more activities in activity data 210.

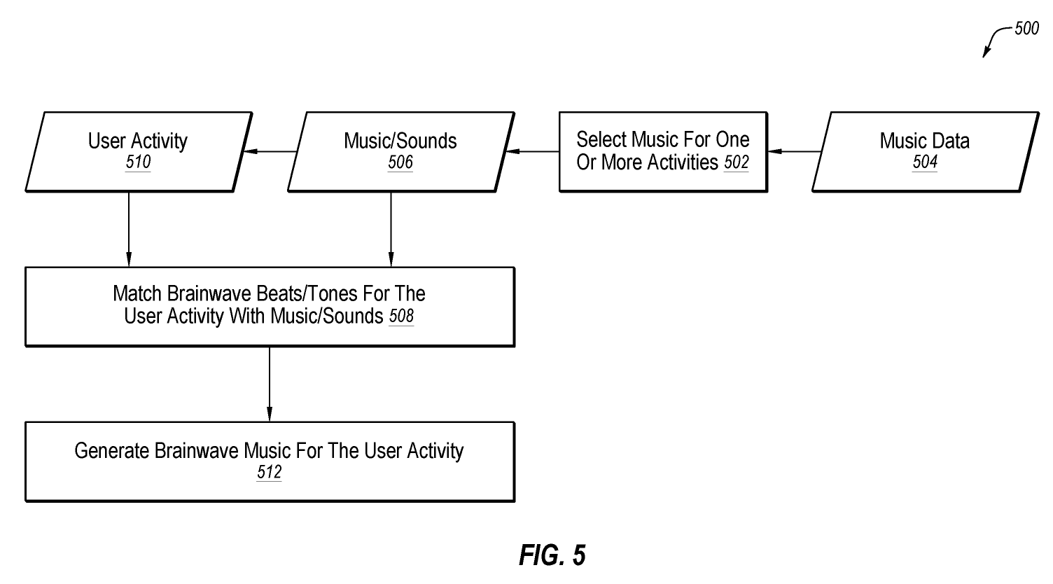

For example, FIG. 5 is a diagram of an example flow 500 that may be used in generating brainwave music for one or more user activities, in accordance with at least one embodiment of the present disclosure. Flow 500 may be performed by any suitable system, apparatus, or device. For example, system 100 (FIG. 1), system 600 (FIG. 6), or one or more of the components thereof may perform one or more of the operations associated with flow 500. In these and other embodiments, program instructions stored on a computer readable medium may be executed to perform one or more of the operations of flow 500.

At block 502, based on music data 504 (e.g., music preferences of a user and/or user comments regarding music), music for one or more activities may be selected to generate music and/or sounds 506 (e.g., the user's favorite music and/or sounds). For example, the music for one or more activities may be selected via mapping table 400 (see FIG. 4). For example, music data 504 may include user music data 110 of FIG. 1.

At block 508, brainwave sounds (e.g., brainwave beats and/or tones) for activity 510 (e.g., a current or upcoming activity included in activity data 216) may be mixed with music and/or sounds 506. Further, at block 512, brainwave music, including music and/or sounds, may be generated for activity 510.

Modifications, additions, or omissions may be made to the flow 500 without departing from the scope of the present disclosure. For example, the operations of flow 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments. In short, flow 500 is merely one example of generating brainwave music for one or more user activities, and the present disclosure is not limited to such.

With reference again to FIG. 2, at block 228, based on brainwave music 224 and/or context data 226 (e.g., context data 112; see FIG. 1), music including brainwave sounds (e.g., beats/tones) may be adjusted and recommended to the user.

For example, based on one or more user responses (e.g., vital signs (e.g., blood pressure, pulse, etc.) and/or user feedback (e.g., data updates 114) (e.g., user selecting a button indicating that he/she does not like the music), the brainwave music may be stopped and/or adjusted. For example, the brainwave music may be stopped and/or adjusted if a user's blood pressure is abnormal. More specifically, for example, if a user's systolic pressure is 150 millimeters of mercury (mm Hg) or higher, or if the user's diastolic pressure is 90 mm Hg or higher (e.g., hypertension), the brainwave music may be stopped and/or adjusted. As another example, if a user's systolic pressure is less than 90 millimeters of mercury (mm Hg), or if the user's diastolic pressure is less than 60 mm Hg (e.g., hypotension), the brainwave music may be stopped and/or adjusted. Further, the brainwave music may be stopped and/or adjusted if the user's heart rate is abnormal (e.g., above 100 beats per min or below 60 beats per minute.

It is noted that user responses may be sensed by, for example any suitable device and/or sensor (e.g., heart rate monitors, Q-sensors (e.g., to measure emotion response via skin, stress), blood pressure sensors, temperature sensors, oxygen level sensors). Further, sensor data may be conveyed from a sensor to a device (e.g., a user's smartphone) via any communication standard (e.g., Bluetooth LE).

In some examples, brainwave music may be played and context data (e.g., context data 112 of FIG. 1) for the user (e.g., user preferences, user's physiological information, and/or user's real-time motion) may be measured. The context data measured in response to application of brainwave music may be compared to context data measured without application of brainwave music. Based on the comparison, it may be determined whether or not application of the brainwave music is beneficial to the user (e.g., by determining whether the user is comfortable). If the brainwave music is beneficial, the brainwave music may continue. If the brainwave music is not beneficial, the brainwave music may be modified or discontinued.

Additionally or alternatively, brainwave music may be played and a determination may be made as to whether the brainwave music is pleasing to the user (e.g., based on user feedback). If the brainwave music is pleasing to the user, the brainwave music may continue. If the brainwave music is not pleasing to the user, the brainwave music may be modified or discontinued.

Further, in some embodiments, a brainwave group for any activity that includes a certain designation (e.g., important and/or high priority) may be adjusted to a different brainwave group (e.g., from Delta to Alpha, Alpha to Beta, Alpha to Delta, etc.).

Further, for example, at block 230, brainwave music for one or more of the user's activities may be recommended to the user. At block 232, personalized content (e.g., brainwave music and/or one or more notifications) may be conveyed to the user (e.g., played via a user device) at a designated time. For example, brainwave music may be played and substantially simultaneously a notification (e.g., via a message (e.g., verbal or textual) may be conveyed to the user.

At block 238, music may be selected and/or recommended based on user profile data 236 (e.g., profile data 106 of FIG. 1) and/or music database 234 (e.g., user music data 110 of FIG. 1). Further, music data (e.g., the user's favorite music and/or sounds) 222 may be generated based on the music selected and/or recommended at block 238.

Modifications, additions, or omissions may be made to the flow 200 without departing from the scope of the present disclosure. For example, the operations of flow 200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments. In short, flow 200 is merely one example of generating personalized content for a user and/or delivering the personalized content to the user, and the present disclosure is not limited to such.

Various contemplated example use cases will now be described. In one example, an athlete may use an application (e.g., application program 102; see FIG. 1) and may provide input (e.g., music preferences (e.g., the athlete's favorite music, favorite artists, favorite genre, favorite instruments, etc.), comments, etc.) to a user profile. The athlete may also input one or more user schedules. For example, the athlete may input one or more training schedules for a time period (e.g., a year including weekly or monthly schedules). Further, for example, the athlete may provide event schedules (e.g., tournament schedules, game schedules, etc.).

In addition, the athlete may check (e.g., periodically, such as every morning or every night), his or her schedule for the day, and enter any changes. Further, the athlete may provide comments with any provided changes.

Upon waking-up and preparing for the day, the athlete may listen to brainwave music (e.g., “wake-up” music) played by the application (e.g., via the athlete's user device, such as a mobile device). Further, after, for example, breakfast, the athlete may travel to a gym for training. On the way to the gym, the application may remind the athlete (e.g., via one or more notifications) of an upcoming athletic event (e.g., an upcoming tournament). Further, the application may enhance the athlete's motivation by providing one or more notifications including motivational content to the athlete. Listening to personalized brainwave music (e.g., as desired by the athlete) and/or receiving one or more notifications may help the athlete mentally prepare for, for example, training and upcoming events.

Further, during, for example, training, the application may detect (e.g., via one or more sensors) one or more conditions of the athlete (e.g., increased stress level, increased heart rate, abnormal brain activity, and/or dizziness). In response thereto, the application may adjust (e.g., slow down or stop) the brainwave music (e.g., to counteract any negative responses). Moreover, after a time period, one or more sensors may indicate that the athlete's stress level has decreased. In response thereto, the application may adjust (e.g., speed up) the brainwave music for enhancing the athlete's training.

The personalized content (e.g., brainwave music and/or notifications) may enhance, and possibly optimize, everyday life of the athlete. For example, the application may increase the athlete's confidence and/or motivation due to, for example, the athlete's training schedule being up to date with the athlete's condition. Further, the athlete's mental condition may be optimized as a result of listening to brainwave music and/or receiving one or more notifications.

In another example, a student may use an application (e.g., application program 102; see FIG. 1) and may provide input (e.g., music preferences (e.g., the student's favorite music, favorite artists, favorite genre, favorite instruments, etc.), comments, etc.) to a user profile. The student may also input one or more user schedules. For example, the student may input one or more exam schedules for a time period (e.g., exams in the next week or more).

In addition, the student may check (e.g., periodically, such as every morning or every night), his or her schedule for the day, and enter any changes. Further, the student may provide comments with any provided changes.

Upon waking-up and preparing for the day, the student may listen to brainwave music played by the application (e.g., via the athlete's user device, such as a mobile device). Further, the application may provide a notification to remind the student of one or more upcoming exams. In response to the music (e.g., as desired by the students) and/or one or more reminders (e.g., via one or more notifications), the student's stress caused by one or more upcoming exams may be decreased. More specifically, for example, during the student's studying time, instead of feeling anxious thinking about the exams, the student may feel calm and focused (e.g., due to the brainwave music).

Further, at some point, the application may detect (e.g., via one or more sensors) that the student is tired. The application may play “resting music” (e.g., rather than “studying” music) as the student gets ready to sleep.

The personalized content (e.g., brainwave music and/or notifications) may enhance, and possibly optimize, everyday life of the student. For example, the application may increase the student's confidence and/or motivation to study, as the student is confident he or she is making the most of his or her time. Further, the student's mental condition may be optimized as a result of listening to brainwave music and/or receiving one or more notifications.

In yet another example, a medical patient may use an application (e.g., application program 102; see FIG. 1) and may provide input (e.g., music preferences (e.g., the patient's favorite music, favorite artists, favorite genre, favorite instruments, etc.), comments, etc.) to a user profile. The patient may also input one or more user schedules. For example, the student may input one or more treatment schedules for a time period (e.g., schedule medical treatments for the next month).

Upon waking-up and preparing for the day, the patient may listen to brainwave music played by the application (e.g., via the athlete's user device, such as a mobile telephone). Further, the application may provide the patient with reminders (e.g., via one or more notifications) regarding daily treatment and exercise.

For example, at 7 AM, the application may provide the patient with a reminder about taking a morning walk while the patient listens to the patient's brainwave music. Further, the application may monitor the patient's condition during the walk.

In addition, at 7:50 AM, ten minutes prior to the patient's scheduled breakfast, the application may remind the patient to eat healthy. Moreover, at some time, the application may detect an increased stress level for the patient. In response to the increased stress level, the application may play the patient's favorite brainwave music for relaxing.

The personalized content (e.g., brainwave music and/or notifications) may enhance, and possibly optimize, everyday life of the patient. For example, the application may increase the patient's outlook about life, as the patient knows that he or she is making progress with treatment, the patient is eating healthy, and/or the patient is exercising regularly. Further, the application may assist in enhancing the patient's mood.

FIG. 6 is a block diagram of an example computing system 600, in accordance with at least one embodiment of the present disclosure. For example, system 100 of FIG. 1 may be implemented as computing system 600. Computing system 600 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing system 600 may include a processor 610, a storage device 620, a memory 630, and a communication device 640. Processor 610, storage device 620, memory 630, and/or communication device 640 may all be communicatively coupled such that each of the components may communicate with the other components. Computing system 600 may perform any of the operations described in the present disclosure.

In general, processor 610 may include any suitable special-purpose or general-purpose computer, computing entity, or processing device including various computer hardware or software modules and may be configured to execute instructions stored on any applicable computer-readable storage media. For example, processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, processor 610 may include any number of processors configured to perform, individually or collectively, any number of operations described in the present disclosure.

In some embodiments, processor 610 may interpret and/or execute program instructions and/or process data stored in storage device 620, memory 630, or storage device 620 and memory 630. In some embodiments, processor 610 may fetch program instructions from storage device 620 and load the program instructions in memory 630. After the program instructions are loaded into memory 630, processor 610 may execute the program instructions.

For example, in some embodiments one or more of the processing operations of a device (e.g., a client, a server, etc.) may be included in data storage 620 as program instructions. Processor 610 may fetch the program instructions of one or more of the processing operations and may load the program instructions of the processing operations in memory 630. After the program instructions of the processing operations are loaded into memory 630, processor 610 may execute the program instructions such that computing system 600 may implement the operations associated with the processing operations as directed by the program instructions.

Storage device 620 and memory 630 may include computer-readable storage media for carrying or having computer-executable instructions or data structures stored thereon. Such computer-readable storage media may include any available media that may be accessed by a general-purpose or special-purpose computer, such as processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 610 to perform a certain operation or group of operations.

In some embodiments, storage device 620 and/or memory 630 may store data associated with generating and/or delivering personalized content to a user. For example, storage device 620 and/or memory 630 may store, for example, user data, such as sound content 104, user profile data 106, schedule data 108, context data 112, music data 110, and/or personalized content 115 (see FIG. 1).

Communication device 640 may include any device, system, component, or collection of components configured to allow or facilitate communication between computing system 600 and another electronic device. For example, communication device 640 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 640 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 6 without departing from the scope of the present disclosure. For example, computing system 600 may include more or fewer elements than those illustrated and described in the present disclosure. For example, computing system 600 may include an integrated display device such as a screen of a tablet or mobile phone or may include an external monitor, a projector, a television, or other suitable display device that may be separate from and communicatively coupled to computing system 600.

As used herein, the terms “module” or “component” may refer to specific hardware implementations configured to perform the operations of the module or component and/or software objects or software routines that may be stored on and/or executed by system 600. In some embodiments, the different components and modules described herein may be implemented as objects or processes that execute on a computing system (e.g., as separate threads). While some of the system and methods described herein are generally described as being implemented in software (stored on and/or executed by system 600), specific hardware implementations or a combination of software and specific hardware implementations are also possible and contemplated. In this description, a “computing entity” may include any computing system as defined herein, or any module or combination of modules running on a computing system such as system 600.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of providing personalized brainwave music to a user, comprising:
receiving user data for a user;
generating personalized brainwave music for the user based on the user data; and
providing the personalized brainwave music to the user at a designated time.

2. The method of claim 1, wherein receiving user data comprises receiving at least one of user profile data, user schedule data, user music data, and user context data.

3. The method of claim 1, further comprising:
identifying at least one notification event for the user based on the user data; and
conveying at least one notification for the at least one notification event to the user at at least of the designated time and another designated time.

4. The method of claim 3, further comprising adjusting the at least notification event based on at least one modification to the user data.

5. The method of claim 1, wherein generating personalized brainwave music comprises mixing at least one brainwave sound with user music data.

6. The method of claim 1, wherein generating personalized brainwave music comprises:
classifying one or more scheduled activities for the user;
matching the one or more classified activities with one or more brainwave effects to categorized the one or more classified activities into one or more brainwave groups; and
identifying personalized brainwave music to be generated for the one or more classified activities based on the one or more brainwave groups.

7. The method of claim 1, wherein generating personalized brainwave music comprises generating brainwave music for at least one scheduled activity of one or more schedule activities for the user.

8. The method of claim 7, wherein conveying the personalized brainwave music to the user at a designated time comprises conveying the personalized brainwave music to the user prior to or during the at least one scheduled activity.

9. The method of claim 1, further comprising recommending brainwave music to a user based on the generated personalized brainwave music.

10. The method of claim 1, further comprising adjusting the personalized brainwave music based on at least one update to the user data.

11. A non-transitory computer-readable medium having computer instructions stored thereon that are executable by a processing device to perform or control performance of operations comprising:
receiving user data for a user;
generating personalized brainwave music for the user based on the user data; and
providing the personalized brainwave music to the user at a designated time.

12. The non-transitory computer-readable medium of claim 11, wherein receiving user data comprises receiving at least one of user profile data, user schedule data, user music data, and user context data.

13. The non-transitory computer-readable medium of claim 11, the operations further comprising:
identifying at least one notification event for the user based on the user data; and
conveying at least one notification for the at least one notification event to the user at at least of the designated time and another designated time.

14. The non-transitory computer-readable medium of claim 13, the operations further comprising adjusting the at least notification event based on at least one modification to the user data.

15. The non-transitory computer-readable medium of claim 11, wherein generating personalized brainwave music comprises mixing at least one brainwave sound with user music data.

16. The non-transitory computer-readable medium of claim 11, wherein generating personalized brainwave music comprises:
classifying one or more schedule activities for the user;
matching the one or more classified activities with one or more brainwave effects to categorized the one or more classified activities into one or more brainwave groups; and
identifying personalized brainwave music to be generated for the one or more classified activities based on the one or more brainwave groups.

17. The non-transitory computer-readable medium of claim 11, wherein generating personalized brainwave music comprises generating brainwave music for at least one scheduled activity of one or more schedule activities for the user.

18. The non-transitory computer-readable medium of claim 18, wherein conveying the personalized brainwave music to the user at a designated time comprises conveying the personalized brainwave music to the user prior to or during the at least one scheduled activity.

19. The non-transitory computer-readable medium of claim 11, the operations further comprising recommending brainwave music to a user based on the generated personalized brainwave music.

20. The non-transitory computer-readable medium of claim 11, the operations further comprising adjusting the personalized brainwave music based on at least one update to the user data.
